(19) United States
(12) Patent Application Publication
(10) Pub. No.: US 2013/0100269 A1
(43) Pub. Date: Apr. 25, 2013

(54) System and Method for Assessing an Individual's Physical and Psychosocial Abilities

(71) Applicants: Jay Shiro Tashiro, Tucson, AZ (US); Patrick C. K. Hung, Markham (CA)

(72) Inventors: Jay Shiro Tashiro, Tucson, AZ (US); Patrick C. K. Hung, Markham (CA)

(21) Appl. No.: 13/657,779

(22) Filed: Oct. 22, 2012

Related U.S. Application Data
(60) Provisional application No. 61/549,578, filed on Oct. 20, 2011.

(51) Int. Cl. H04N 7/18

(52) U.S. Cl. 348/77; 348/E07.085

(57) ABSTRACT

A system is presented for assessing an individual's physical or psychosocial abilities. The system comprises a server having a processor and non-transitory computer readable medium in communication with the system. The non-transitory computer readable medium has instructions encoded thereon to receive a video-audio data stream from one or more video cameras in communication with the server, establish a threshold for a parameter that can be measured using the video-audio data streams received, measuring the parameter using the video-audio data streams received, and comparing the measure parameter with the threshold. From the comparison of the measured parameter and the threshold the individual's physical or psychosocial abilities can be assessed.

### CROSS-REFERENCE TO RELATED APPLICATIONS

This Non-Provisional Application claims priority to a U.S. Provisional Application filed Oct. 20, 2011 and having Ser. No. 61/549,578, is incorporated by reference herein.

### FIELD OF THE INVENTION

The present invention relates generally to systems and methods for assessing an individual's abilities and more particularly to video and audio data analysis systems and methods of using the same for evaluating the physical and psychosocial abilities of an individual.

### BACKGROUND

In today's healthcare and educational systems, there is a need for data collection and analysis systems that efficiently allow for the collection and assessment of comprehensive and high quality data concerning an individual's capacity for physical activity, psychosocial engagement, and their ability to demonstrate their knowledge and skills. Deficiencies in the prior art arise in part because the care of patients, fitness training, and education of students occur within settings that differ in temporal and spatial heterogeneity. For example, in both clinical and home settings, the circumstances of care, the number and types of care giving personnel, and the equipment used to deliver care may vary through time (e.g., moment to moment changes in the circumstances as well as availability of personnel and equipment) and space (e.g., variation across location in terms of circumstances as well as availability of personnel and equipment). Likewise, course and classroom or online interactions also vary through time for students at all academic levels.

A second factor which contributes to the deficiency of the prior art arises from the fact that each individual experiences physiological, psychosocial, and cognitive variations over time as they cope with an injury or disease or as they progress through an educational program. In short, there is a tremendous complexity in the interactions between the temporal variability of both the environment in which healthcare or education is delivered and a patient's or student's physiological and psychosocial processes and capacities. Evidence-based practices in both healthcare and education have been difficult to implement as the complexities between human physiological and psychosocial systems have a multivariant nature. Moreover, both healthcare and educational interventions are also multivariant in nature and confound the difficulties of implementing evidence-based practices within the care giving or educational setting for any particular health or educational goal. There currently is a lack of any tool that provides an efficient means for data collection, analysis, and interpretation of the emergent complexities between human physiological and psychosocial systems and the multivariant nature of healthcare and educational interventions.

An additional deficiency in the prior art is due to the fact that the prior art does not provide solutions to the first two noted deficiencies in ways that allow for measurement in healthcare or educational settings of at least two kinds of competencies: conceptual competencies and performance competencies. By “conceptual competencies” it is meant, for example, an individual's understanding of a knowledge and/or skill domain. By “performance competencies” it is meant, for example, the ability of a person to act on his/her knowledge as expressed by their behaviors and decisions in a natural environment. This third deficiency can be understood by considering an example of an elderly man who has had a total right hip replacement and is in physical therapy for rehabilitation. The man's conceptual competencies include his ability to describe and understand what was done to his hip, why the surgery was necessary, and what the impacts of the hip replacement are on his balance, fall risk, and activities of daily living while his performance competencies include his ability to engage in the physical rehabilitation in a meaningful manner and to make behavioral changes consistent with sound rehabilitation strategies recommended by his surgeon and physical therapist. A second example is an athlete, such as a male boxer, who is vulnerable to certain types of counterpunches because of his hand positions and movements. The boxer's conceptual competencies include his understanding of how his hand positions and movements lead to the vulnerability while his performance competencies include his ability to change his behaviors based on that understanding and the sound strategies recommended by his coaches. Another example is a nursing student who has completed a course that included lessons and practice in wound care and is asked to engage in a demonstration of how to change a dressing for a serious wound in the upper left leg of a patient. The student's conceptual competencies include her ability to describe and understand the reasons for and procedures involved with changing the dressing for a wound of that nature while her performance competencies include her ability to demonstrate behaviors consistent with the practices she has learned. Currently, there is no prior art method that allows for the creation of customizable assessments in which an individual's conceptual and performance competencies can be measured automatically.

A fourth deficiency in the prior art arises because known healthcare, fitness, and educational assessments must have an adequate sampling of the variables related to the assessments goals. Using the previous examples, such variables for the respective examples would have to be related to improved healthy behaviors and rehabilitation for the hip replacement patient, improved strategies and skills for the boxer, and improved clinical knowledge and skill demonstration for the nursing student. As both the individual and his/her situated experience becomes more temporally and spatially heterogeneous, increased amounts of high quality data must be collected in order to assess the critical variables.

A fifth factor which contributes to the deficiency of the prior art arises because of the absence of a comprehensive theoretical framework that would inform selection of processes for data collection and analysis of an individual's conceptual and performance outcomes, stability of these outcomes, and transferability of these outcomes to real world behaviors. For example, even if the third and fourth deficiency described above could be addressed, current intelligence systems, data mining applications, and other analytical systems have not captured the breadth and depth of the temporal and spatial heterogeneity of healthcare planning and delivery, fitness training, and education. Furthermore, the prior art fails to provide empirically derived educational methods and materials that facilitate ongoing interventions likely to create opportunities for enhanced improvement in health, fitness, and educational outcomes.

A sixth deficiency in the prior art arises because of the fact that even if the prior five noted deficiencies could be overcome, individual clinicians, coaches, and educators do not agree on a singular theory of cognition or of behavioral change. Consequently, the prior art fails to provide methods and materials that have the flexibility to accommodate any theory of cognition and/or behavioral change because each theory or theory combination would have particular types of healthcare, fitness, or educational frameworks and outcomes assessments as well as particular types and arrangements of educational scaffolding to support an individual within a healthcare, fitness, or educational environment. This deficiency also results in an inability of prior art to follow patterns in learning and behavioral expression of what has been learned that would allow delineation of misconception development within a theory-grounded or evidence-based framework.

The above described sixth deficiency leads to a seventh deficiency that is currently evident in the clinical and educational transformations now underway worldwide. More specifically, there has been a series of changes in how health and education records are constructed, stored, and used. In healthcare planning and care delivery, the transformation has been development and wide-scale implementation of various types of electronic health records and electronic medical records. In education, there has been a transformation leading to more comprehensive digitized or electronic records of student learning.

Prior art methods have tried to couple activities to outcome assessments using knowledge-based systems, data mining applications, and other analytical systems to measure: the physical and psychosocial attributes of an individual in a healthcare setting or in educational settings, what an individual has learned, the stability of the learning, and the individual's ability and disposition to translate the learning into behavior. However, these prior art methods fail to provide an adequate sampling of data at any one time, let alone over a time period, to provide sufficient information to portray accurately the likely accurately and completely the physical and psychosocial attributes of individuals within healthcare settings or the conceptual performance competencies of learners within an educational settings especially the evidence-based outcomes of educational methods and materials on an individual's development, retention and application of knowledge and skills. Furthermore, the prior art methods do not allow the flexibility to customize healthcare planning care delivery, and patient education nor teaching-learning-assessment environments in ways that would accommodate different theories of cognition or behavioral change resulting from health or educational interventions. Furthermore, the prior art does not provide customization related to theories of cognition and behavioral change that allow theory-grounded and praxis-grounded identification of learning pathways that lead to misconception development.

The seven deficiencies noted contribute to a general failure of the prior art to collect sufficient high quality data on healthcare, fitness, and educational outcomes or to interpret such data in a manner that enhances the management and outcomes of ongoing interventions. Thus using prior art methods, it is not possible to analyze the trajectories of critical variables that shape healthcare and educational outcomes, the stability of such outcomes, the transferability of the knowledge or skills gained by patients or students, and the subsequent enhancement of such outcomes as the theory and practices of healthcare and education are farther developed.

### SUMMARY

The present invention provides a video-audio data collection, management, and analysis system for use in healthcare, fitness, and educational programs and that increases the quality of the data collected as well as the analysis and interpretation of that data, allowing for the assessment of a diverse array of critical capacities in an individual. Such capacities include, but are not limited to: (1) physical capacities (e.g., balance, fall risk, and ability to perform routine activities of daily living); (2) psychosocial capacities (e.g., mental status, ability to communicate, and ability to engage in complex social interactions); and (3) capacities for knowledge and skill mastery demonstration (e.g., demonstration of conceptual competencies, mastery of procedural knowledge as demonstrated by their performance competencies, demonstration of metacognitive abilities related to problem-solving and pattern recognition, and communication of what the individual knows, can do, and is doing). More specifically, the present invention combines the capture of video-audio data streams with analytical tools to overcome the deficiencies noted in the prior art. As is subsequently explained in detail, the video-audio data streams provide large volumes of high quality data on an individual's physical, psychosocial, knowledge, and skills demonstration capacities. Importantly, the data can be viewed in a time series of changing situated experiences of the individual. The analytical tools of the invention further provide new ways to assess the complexities of conceptual and performance competency expression. Additionally, the analytical tools of the method meet the need to be interoperable with the extant and emerging electronic records of healthcare and educational systems.

In one embodiment, a system is presented for assessing an individual's physical or psychosocial abilities. The system comprises a server having a processor and non-transitory computer readable medium in communication with the processor. The non-transitory computer readable medium has instructions encoded thereon to receive a video-audio data stream from one or more video cameras in communication with the server, establish a threshold for a parameter that can be measured using the video-audio data streams received, measuring the parameter using the video-audio data streams received, and comparing the measured parameter with the threshold. From the comparison of the measured parameter and the threshold the individual's physical or psychosocial abilities can be assessed.

In another embodiment, a method is provided for assessing an individual's physical or psychosocial abilities. The method comprises providing at least one video camera and a server in communication with the camera, where the server includes a processor and non-transitory computer readable medium in communication with the system. The non-transitory computer readable medium further has instructions encoded thereon to receive a video-audio data stream from one or more video cameras in communication with the server, establish a threshold for a parameter that can be measured using the video-audio data streams received, measuring the parameter using the video-audio data streams received, and comparing the measured parameter with the threshold. From the comparison of the measured parameter and the threshold the individual's physical or psychosocial abilities can be assessed. The method further includes capturing a video-audio data stream from each of the video cameras, establishing a threshold for the parameter, measuring the parameter, and comparing the parameter with the threshold.

### BRIEF DESCRIPTION OF THE DRAWINGS

Implementations of the invention will become more apparent from the detailed description set forth below when taken in conjunction with the drawings, in which like elements bear like reference numerals.

FIG. 1 is an exemplary schematic of Applicants' system for assessing the physical and psychosocial abilities of an individual;

FIG. 2A is an exemplary flowchart of a method of using the system of FIG. 1; and

FIG. 2B is an exemplary flowchart of a method of analyzing video-audio data streams recorded using the system of FIG. 1 to assess the physical and psychosocial abilities of an individual.

### DETAILED DESCRIPTION

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Many of the functional units described in this specification have been labeled as modules (e.g., modules 300 and 400) in order to more particularly emphasize their implementation independence. For example, a module (e.g., modules 300 and 400) may be implemented as a hardware circuit comprising custom VLSI circuits or gate arrays, off-the-shelf semiconductors such as logic chips, transistors, or other discrete components. A module (e.g., modules 300 and 400) may also be implemented in programmable hardware devices such as field programmable gate arrays, programmable array logic, programmable logic devices, or the like.

Modules (e.g., modules 300 and 400) may also be implemented in software for execution by various types of processors. An identified module of executable code may, for instance, comprise one or more physical or logical blocks of computer instructions which may, for instance, be organized as an object, procedure, or function. Nevertheless, the executables of an identified module (e.g., modules 300 and 400) need not be physically collocated, but may comprise disparate instructions stored in different locations which, when joined logically together, comprise the module and achieve the stated purpose for the module.

Indeed, a module of executable code (e.g., modules 300 and 400) may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The schematic diagrams included are generally set forth as logical diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method.

Although various arrow types and line types may be employed in the flow diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

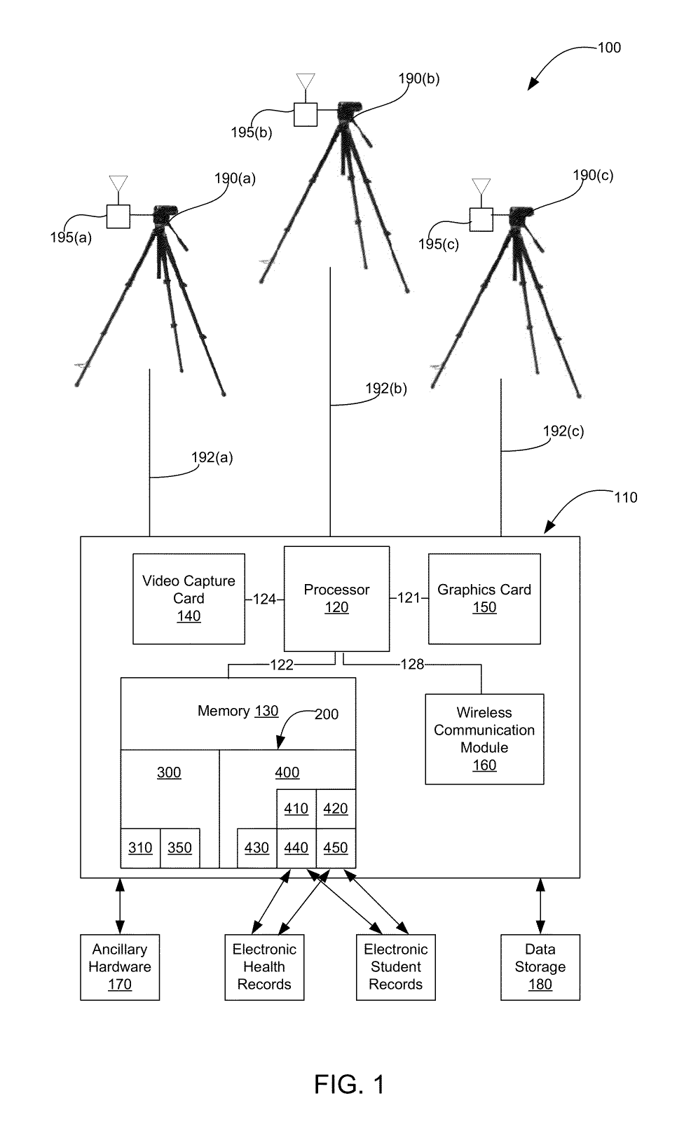

Applicants' invention includes a method and system for collecting and assessing data regarding the physical abilities and knowledge of an individual over a period of time. An embodiment of Applicants' system is presented in FIG. 1. As can be seen in FIG. 1, Applicants' system 100 comprises one or more cameras 190 in communication with server 110. While FIG. 1 illustrates three video cameras, cameras 190(a), 190(b), and 190(c), in communication with server 110, one of ordinary skill in the art will understand this to be exemplary and not limiting. In certain embodiments, Applicants system 100 comprises more than three cameras. In yet other embodiments, Applicants system 100 comprises less than three cameras.

In certain embodiments, cameras 190(a), 190(b), and 190(c) are in communication with server 110 via communication links 192(a), 192(b), and 192(c), respectively. In such embodiments, one or more of communication links 192(a), 192(b), and 192(c) are camera cables, such as, and without limitation, HDMI (High-Definition Multimedia Interface) cable, IEEE 1394 FireWire cable, audio/video cable, USB (Universal Serial Bus) cable, and the like. In yet other embodiments, one or more of cameras 190(a), 190(b), and 190(c) are in communication with server 110 via wireless communication. In such embodiments, one or more of cameras 190(a), 190(b), and 190(c) communicate wirelessly through wireless communication devices 195(a), 195 (b), and 195(c) with server 110 via optional wireless communication module 160. In certain embodiments, wireless communication module 160 utilizes WIFI communication protocols. In certain embodiments, wireless communication module 160 utilizes BLUE TOOTH communication protocols.

In certain embodiments, medical diagnostic devices external to system 100 can wirelessly provide data to server 110 via wireless communication module 160. Such medical diagnostic devices include, without limitation, ultrasound imaging devices, X-ray imaging devices, MRI imaging devices, blood pressure monitors, blood sugar monitors, and the like. In certain embodiments, the external medical diagnostic data is interleaved in real time with the video data generated by system 100, and that composite data is stored in Data Storage module 180 for later analysis. In certain embodiments, the external medical diagnostic data is appended in real time to the video data as a continuous annotation. In certain embodiments, the appended continuous medical diagnostic data annotation can be simultaneously visually displayed in combination with the video data, such the a display device simultaneously provides video data showing a patient orientation at a time T(1) in combination with a data display comprising one or more of the patient's blood pressure at time T(1), blood sugar at time T(1), pulse rate at time T(1), body temperature at time T(1), MRI image at time T(1), ultrasound image at time T(1), and/or X ray image at time T(1).

In the illustrated embodiment of FIG. 1, server 110 comprises processor 120 in communication with non-transitory memory 130 via communication link 122. In certain embodiments, memory 130 comprises a magnetic information storage medium, an optical information storage medium, an electronic information storage medium, and the like. By “magnetic storage medium,” it is meant, for example, a device such as a hard disk drive, floppy disk drive, or magnetic tape. By “optical information storage medium,” it is meant, for example, a Digital Versatile Disk (“DVD”), High-Definition DVD (“HD-DVD”), Blu-Ray Disk (“BD”), Magneto-Optical (“MO”) disk, Phase-Change (“PC”) disk, etc. By “electronic storage media” it is meant, for example, a device such as PROM, EPROM, EEPROM, Flash PROM, compactflash, smartmedia, and the like. In certain embodiments, memory 130 comprises a magnetic information storage medium, an optical information storage medium, an electronic information storage medium, or the like.

In certain embodiments, memory 130 includes instructions 200. In such embodiments, instructions 200 further includes recording module 300 and data management module 400. Recording module 300 and data management and analysis module 400 are each discussed subsequently in detail.

In certain embodiments, processor 120 is further in communication with optional video capture card 140 via communication link 124. As those skilled in the art will appreciate, optional video capture card 140 is a video capture device which plugs into an expansion slot of server 110.

In certain embodiments, processor 120 is further in communication with optional graphics card 150. As those skilled in the art will appreciate, optional graphics card 150 is an expansion card which generates output images to a display.

In such embodiments where one or more of cameras 190(a), 190(b), and 190(c) are wirelessly in communication with server 110 via wireless communication devices 195a-c, and/or via communication links 192a-c, server 110 further comprises optional wireless communication module 160 in communication with processor 120 via communication link 128.

In certain embodiments, server 110 is further in communication with ancillary hardware 170. By way of example and not limitation, ancillary hardware 170 may comprise one or more of a monitor, keyboard, mouse, dial controls, speakers, microphone, and the like.

In certain embodiments, server 110 is further in communication with a secondary data storage, data storage 180. In such embodiments, data storage 180 may include, without limitation an external magnetic information storage medium, optical information storage medium, and/or electronic information storage medium.

Recording module 300 comprises instructions for video capture submodule 310 and video sync submodule 350. As is discussed subsequently in greater detail, video capture submodule 310 provides for the video capture of healthcare, fitness, and educational activities from multiple perspectives using one or more of cameras 190(a), 190(b), and 190(c) while video sync submodule 350 couples the captured video with concomitant audio data streams and where, more than one camera angle is captured, synchronizes the multiple video-audio data streams, allowing for the simultaneous portrayal of different camera angels on a display peripheral to server 110. Thus, recording module 300 allows for the capture of high quality data concerning an individual's capacities including, but not limited to, physical capacities (e.g., balance, fall risk, ability to perform routine activities of daily living, and the like), psychosocial capacities (e.g., mental status, ability to communicate, ability to engage in complex social interactions), and capacities for knowledge and skill mastery demonstration (e.g., demonstration of conceptual and performance competencies, mastery of procedural knowledge as demonstration of skills, and demonstration of metacognitive abilities related to problem-solving and pattern recognition).

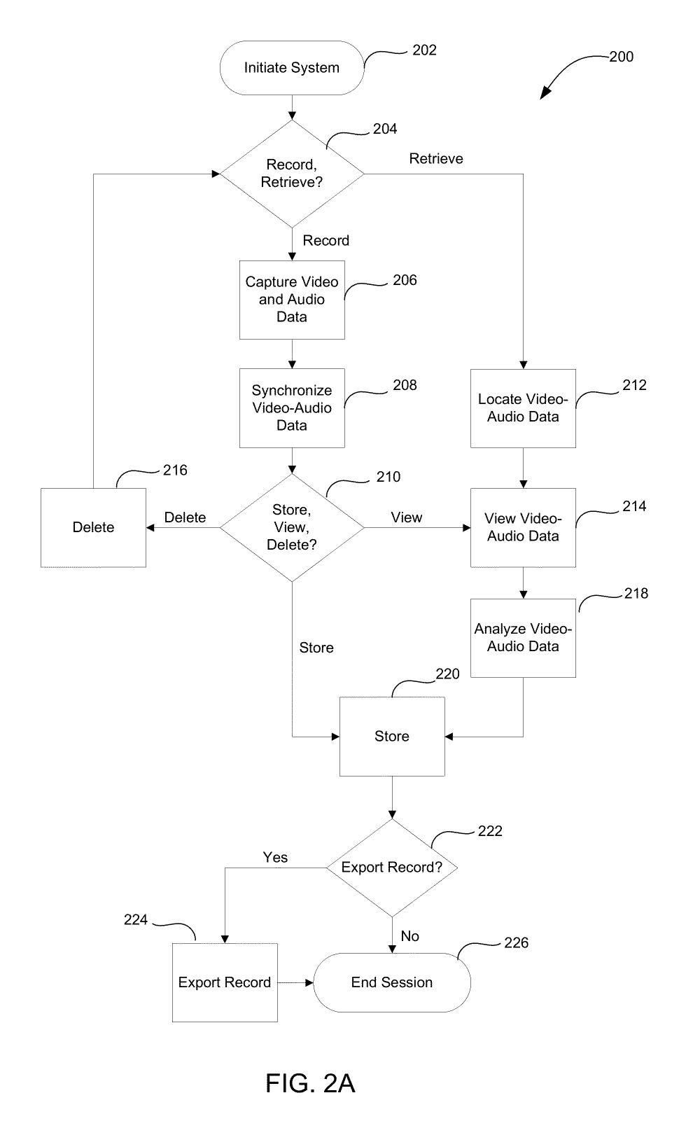

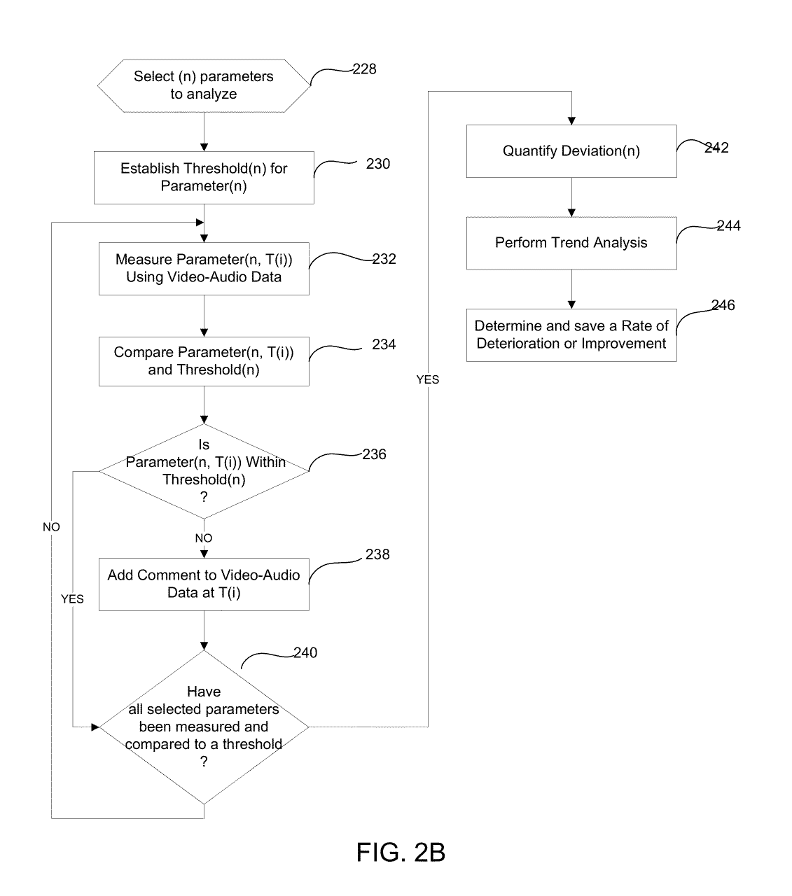

Data management and analysis module 400 provides for the data management and analysis of one or more synchronized video-audio data streams from recording module 300 and comprises instructions for data storage submodule 410, retrieval submodule 420, data viewing submodule 430, analysis submodule 440, and import/export submodule 450. Specifically, data storage submodule 410 stores the video-audio data streams recorded using recording module 300. In certain embodiments, the video-audio data streams are stored in memory 130. In other embodiments, the video-audio data streams are stored in data storage 180. In certain embodiments, the data is stored with meta tags for easy identification and retrieval. Data retrieval submodule 420 allows for the retrieval of stored video-audio data streams. In certain embodiments, data retrieval submodule 420 includes instructions for retrieving video-audio data streams using methods such as a key word search, a menu-driven retrieval, and the like. Once retrieved, the stored video-audio data streams can be played visually and audibly on ancillary monitors and speakers in communication with server 110 by data viewing submodule 430. Using analysis submodule 440, a user can analyze the video-audio data streams, as is described subsequently in connection with FIG. 2B. Export submodule 450 can then be used to collate, configure, and export the analysis and the original or edited video-audio data stream. In certain embodiments, such export would be provided as a set of one or more videos, a video player, and a PDF or other analysis format, which in other embodiments that export would result in transfer of the video-audio records and analysis through interoperability interfaces to electronic records for example electronic health records in healthcare systems or electronic student records in educational settings.

In certain embodiments, Applicants' system 100 is further combined with additional assessment tools to provide a more comprehensive healthcare, fitness, and educational profile of an individual. For example, Applicants' system 100 may be integrated with healthcare records to create and maintain a more complete record of an individual through time. In such embodiments, data from the individual's videos and analysis may be sent to a healthcare record as mentioned above, or receive data from a healthcare record. Either pathway allows additional analysis options. Data from the embodiment to the healthcare record allows analysis by tools in the record or by those in the embodiment activated by the record. Data from the healthcare record to the embodiment allows analysis by tools in the embodiment or by tools in the healthcare record that are activated by the embodiment. Alternatively, fitness and educational assessments can be tied to specific training, course, or curriculum information. In such embodiments, information from the training, course, or curriculum as well as from a student's or trainee's electronic record may be integrated with the video-audio stream to provide a fuller understanding of an individual's progress and knowledge, allowing for a more accurate assessment of the individual.

Applicants' system 100 as shown in FIG. 1 can be used to capture and assess data regarding the physical abilities and knowledge of an individual over a period of time in a manner which makes it possible to analyze the trajectories of critical variables that shape health, fitness, and educational outcomes as well as the potential for knowledge deficits and misconception development. FIG. 2 summarizes Applicants' method 200, using Applicants' system 100. As can be seen in the illustrated embodiment, a user, having initiated Applicants' system 100, can either work with an existing session stored in either memory 130 or data storage 180 or record a new session using one or more cameras 190, as indicated by blocks 202 and 204. If the user is recording a new session, one or more cameras 190 in communication with server 110 are positioned at different locations around the individual being assessed. As the individual performs a physical task, video and audio data is captured using video capture submodule 310 of recording module 300, as indicated by block 206. As will be appreciated, each camera 190 that is used produces a separate video-audio data stream. Thus, the use of three cameras results in three video-audio data streams, four cameras in four video-audio data streams, and so on. In certain embodiments, the user can view the separate data streams as they are being recorded using a monitor, to ensure that the task is being performed as instructed. The data streams are then synchronized as indicated by block 208 using the video sync submodule 350, which matches each data stream frame-by-frame in time. As will be appreciated, synchronizing the data streams allows for a more detailed assessment by enabling a user to view what was occurring at any given time from each of the camera angles. Once the video-audio data stream has been synchronized, the user can store the data stream or view and subsequently analyze the data stream, as indicated by block 210. Alternatively, the synchronized data streams can be deleted and additional video-audio data streams can be recorded as indicated by block 216.

Alternatively, as indicated by block 212, when the user chooses to work with existing data streams, the user locates and retrieves the data streams stored in either memory 130 or data storage 180 using data retrieval submodule 420 of the data management and analysis module 400. In certain embodiments, data retrieval submodule 420 searches for stored data streams using metadata attached to the data by data storage module 410. Such metadata includes, but is not limited to, an identifier of the individual being assessed, such as a name or number, the date the session was recorded, the system operator, the type of assessment, or any other pertinent information. In certain embodiments a user may instead, or in addition to, select the stored data from a table or directory tree. In certain embodiments a user can retrieve more than one set of synchronized data streams. Still other embodiments allow use of the input/export submodule 450 to import existing data streams.

The captured or retrieved synchronized data streams are then viewed using the ancillary hardware 170, such as a monitor, in communication with server 110, as indicated by block 214. In certain embodiments, the user views the synchronized data stream by advancing the video-audio data frame-by-frame or by playing it at a speed other than the recorded speed. In certain embodiments, the video-audio data is played at a speed less than the recorded speed. In certain embodiments, the video-audio data is played at speeds from 0.1 to 2.0 of the recorded speed.

In certain embodiments, a user may record a new session and subsequently retrieve one or more stored synchronized data streams, for example but not limited to data streams from data storage module 180 or by import from the import/export submodule 450, to view simultaneously with the newly recorded session. As will be appreciated, doing so may assist the user in evaluating the individual's progress over time.

In connection with or in addition to viewing the synchronized data streams, the video-audio data is analyzed using analysis submodule 440 to assess the individual's performance, as indicated by block 218. A flowchart summarizing Applicants' method of analyzing the synchronized data streams using analysis submodule 440 is presented in FIG. 2B. In the embodiment illustrated in FIG. 2B, in block 228 the method selects (n) parameters to analyze, wherein (n) is greater than equal to 1. In certain embodiments, block 228 is performed by processor 120. In certain embodiments, block 228 is performed manually.

In block 230, for each parameter (n) that is being examined, a corresponding threshold is established. In certain embodiments the user defines threshold(n) for the particular parameter(n) being examined. In other embodiments, threshold(n) is retrieved from memory 130 or from data storage 180 or imported by import/export submodule 450. In still other embodiments, threshold(n) is selected by processor 120.

In block 232, parameter(n) is measured at one or more moments in time T(i) along the synchronized video-audio data streams (denoted as parameter(n, T(i)) in FIG. 2B). In block 234, parameter(n) is compared with threshold(n). In certain embodiments, block 234 is performed by processor 120.

In certain embodiments, parameter(n) is only measured once. In such embodiments, parameter(n) may be measured at a critical point in the individual's performance of the requested task. In other embodiments, parameter(n) is measured multiple times throughout the video-audio data. In such embodiments, parameter(n) may be measured at regular time intervals. In other such embodiments, parameter(n) may be measured at irregular time intervals. In certain embodiments, each measurement of parameter(n) is added to or stored with the data streams at the moment in time T(i) at which it was measured. Thus, in such embodiments subsequent users who are viewing the video-audio data streams will not need to remeasure parameter(n).

In certain embodiments, when parameter(n) is outside threshold(n) at moment in time T(i), the user may make a comment that is associated with the video-audio data streams at time T(i), as indicated by block 238. In other embodiments, the user may add a comment to the video-audio data streams at time T(i) regardless of whether parameter(n) is outside the threshold(n) at time T(i). In certain embodiments, the comment is embedded in the video-audio data streams at time T(i) and will be presented to users who subsequently view the video-audio data streams. In other embodiments, the comment is stored separately from the video-audio data streams. In such embodiments, the comment may be stored along with the frame from each of the synchronized video-audio data streams at the moment in time T(i) associated with the comment. In various embodiments, comments can be made in multiple formats. For example, a comment may be dictated and the dictation stored with meta tags that define association with the relevant moment in the video-audio stream, or a comment may be typed into a data field that will be assigned meta tags defining association with the relevant moment in the video-audio stream, or a drawing tool may be used to add annotations to the video frame at a moment of interest and such annotations will be assigned meta tags defining association with the relevant moment in the video-audio stream. The submodules within module 400 recognize such metatags and so allow viewing, retrieval, analysis, and export maintaining the comments with their respective moment in the video-audio stream.

In block 240, the method determines if all the selected parameters have been measured and compared to associated thresholds. In certain embodiments, block 240 is performed by processor 120. If the method determines in block 240 that all the selected parameters have not been measured and compared, then the method transitions from block 240 to block 232. Alternatively, if the method determines in block 240 that all the selected parameters have been measured and compared, then the method transitions from block 240 to block 242

In certain embodiments, the parameter(n) has been measured at each moment in time T(i) of interest, the deviation for parameter(n) (denoted deviation(n) in FIG. 2B) is quantified using statistical methods, as indicated by block 242. In certain embodiments, the deviation(n) is expressed as the difference between the observed value of parameter(n) and the mean value of parameter(n). In other embodiments, the deviation(n) is expressed as a standard deviation. In yet other embodiments, the deviation(n) is expressed as a percent deviation. In still other embodiments, the deviation(n) is expressed as any form of statistical deviation.

As is indicated by block 244, in certain embodiments a trend analysis is performed using additional data taken during previous sessions with the same individual by way of well known statistical methods. In certain such embodiments, the result of the trend analysis is a prediction of future behavior, physical abilities, and/or knowledge of the individual. In certain such embodiments, the trend analysis may be performed as a trend estimation which can be used to identify increasing or decreasing trends. In certain embodiments, the rate of deterioration or improvement over time is also determined using additional data taken during previous sessions with the same individual by way of well known statistical methods, as indicated by block 246.

The process described in connection with blocks 228-246 are repeated for each parameter being examined. Once done, method 200 returns to FIG. 2A and the synchronized video-audio data streams are stored in memory 130 and/or data storage 180 using data storage submodule 410 of data management and analysis module 400, as is indicated by block 220. In certain embodiments, data storage submodule 410 adds metadata and/or digital identification objects to the synchronized video-audio data streams that allow subsequent identification of the session during search and retrieval by the retrieval submodule 420.

As indicated by blocks 222 and 224, a record can be created and exported using import/export submodule 450. In certain embodiments, the record contains one or more of: (1) the synchronized video-audio data streams, (2) a player to view the video-audio data, and (3) the comments and analysis made. In certain embodiments, the comments and analysis are exported in a Portable Document Format (PDF). In certain such embodiments, the PDF further comprises frames from each of the synchronized video-audio data stream at the moment in time T(i) corresponding to the respective comments and analysis. In certain embodiments, import/export submodule 450 creates a folder in memory 130, data storage 180, and/or another external data storage medium in communication with server 110. In such embodiments, import/export submodule 450 then exports the synchronized video-audio data streams, the optional player, and the PDF to the folder.

In certain embodiments, the import/export submodule 450 is interoperable with healthcare electronic health records or electronic medical records (or in educational systems with electronic student records). In such embodiments, the exported data are placed within informatics fields of the specific electronic record of the patient in a healthcare setting or of a student or trainee in an educational system.

In certain embodiments, import/export submodule 450 may additionally print a hard copy of all or part of the exported record. By way of example and not limitation, import/export submodule 450 may print a hard copy of the analysis and any comments or drawings made by the user along with the associated frames from the synchronized video-audio data. Additionally import/export submodule 450 may provide an audio file of dictated comments or an automatically generated transcription of the dictated comments

In certain embodiments, individual blocks described above may be combined, eliminated, or reordered.

In certain embodiments, computer readable program code, such as instructions 200 (FIG. 1), are encoded in computer readable medium, such as memory 130 (FIG. 1), wherein those computer readable program code are executed by a processor, such as processor 120 (FIG. 1), to perform one or more of the blocks 202-246 recited in FIGS. 2A and 2B.

In yet other embodiments, the invention includes computer readable program code residing in any other computer program product, where those computer readable program code are executed by a computer external to, or internal to, a computing system to perform one or more of the blocks 202-246 recited in FIGS. 2A and 2B. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, CompactFlash, SmartMedia, and the like.

The following examples are presented to further illustrate to persons skilled in the art how to make and use the invention. These examples are not intended as a limitation, however, upon the scope of the invention, which is defined only by the appended claims.

### EXAMPLE I

By way of example and not limitation, a clinician may employ Applicants' system 100 to conduct a risk assessment of the likelihood that a patient will fall, where the patient is a post-stroke elderly man who has ongoing balance problems. To perform such an assessment, a clinician first positions one or more video cameras 190 in communication with server 110 around a testing area in which the patient will be asked to perform a physical task which demonstrates his ability to balance. By way of example and not limitation, the patient may be asked to walk a straight line. In such a case, each camera may be positioned to capture audio-video data from different vantage points along the path that the patient will walk, for example, from behind the patient, in front of the patient, and from the side.

Using a monitor and input device in communication with server 110, the clinician initiates a software application stored on server 110 comprising instructions 200 and graphical user interface (GUI) which provides access to the various modules and submodules of instructions 200. As will be appreciated, a GUI represents the information and actions available to a user through graphical and visual indicators and is well known in the art. Through the GUI, the clinician can easily access recording module 300 to start and stop recording video-audio data using cameras 190 as appropriate while the patient is performing the task. Video capture submodule 310 simultaneously turns on and off cameras 190 at the clinician's commands. The video-audio data streams from the different cameras are passed by video capture card 140 of server 110 to video sync submodule 350. The data streams are synchronized frame-by-frame and temporarily recorded in the random access memory (RAM) of server 110. When the patient has finished performing the task, the clinician stops the recording of video-audio data and either deletes the session data or stores it. In alternate embodiments the clinician may proceed with an analysis of the synchronized video-audio data using analysis submodule 440 prior to storing the data in memory. In the present example, the clinician decides to store the session data and enters a name, description, and other identifying information which can be associated with the recorded session data for ease of locating and retrieving the data at a later time. The synchronized video-audio data is then stored in memory 130 or data storage 180.

When the clinician is ready to proceed, the clinician retrieves the synchronized video-audio data streams by activating the data retrieval submodule 420 via the GUI, which allows the clinician to search, select, and retrieve data from one or more sessions for viewing and analysis. Using viewing submodule 430, the clinician can step through the synchronized video-audio data streams frame-by-frame or play them at varying speeds, such as 0.1 to 2.0 of the recorded speed, allowing the clinician to carefully observe and assess the patient's movements while performing the assigned task from the vantage points of the different cameras.

In the present example, the clinician decides to analyze the inclination angle of the patient's upper body as he takes each step, which will give the clinician an indication of the likelihood that the patent will loose his balance when walking. To do so the clinician initiates the analysis module 440 and establishes a threshold for the parameter being measured. In the present example, the clinician enters a threshold based on the average inclination angle of a healthy individual's body when walking. By way of example and not limitation, a healthy individual may list no more than ±10 degrees from a plane perpendicular to the ground. Alternatively, the threshold may be retrieved from memory 130 or data storage 180.

In the present example, the clinician steps through the synchronized video-audio data and selects each moment in time T(i) when the inclination angle of the patient's body is measured. By way of example and not limitation, the clinician may choose to measure the inclination angle for each step the patient takes when the patient's foot is lifted to its highest point and then again when the patient has placed it back on the ground again. In other embodiments, the clinician may choose to measure the inclination angle at every frame or at regular or irregular intervals. In yet other embodiments, the rate at which the measurements are taken may be automatic and not specified by the clinician. In such an embodiment, the clinician may specify a segment of the video-audio data stream to be analyzed. In the present example, the measurements are performed by analysis submodule 440 but in alternate embodiments the clinician may take the measurement herself and enter it using the GUI for subsequent analysis. Such measurements may be accomplished with the system drawing tools, allowing annotation and measurements on the frames at moment T(i) of a particular interest during the clinical assessment. The drawing tools are complemented by voice dictation and typed comments that become clinical progress notes, diagnoses care plans, or treatments.

Each measurement taken is associated with the moment in time T(i) in the video-audio data stream at which it was measured and is compared with the established threshold. When the inclination angle of the patent is outside the threshold the clinician may record a comment, type a comment, add drawings for analysis or description, with these comments and drawing specifically associated with the video-audio data at the moment in time T(i) at which the corresponding measurement was taken. In certain embodiments, the clinician may record additional comments when she notices something of interest or otherwise wants to make a notation. In certain embodiments, the comments made by the clinician are text-based. In other embodiments, the comments are audible. In yet other embodiments, the comments are visual and include drawings or other indications the clinician makes directly onto a frame of the synchronized video-audio data.

When the inclination angle of the patent has been measured for each moment in time T(i) of interest, analysis submodule 440 quantifies the deviation and reports it back to the clinician. By way of example, the measurements taken may show that the inclination angle of the patient's body may be +10% to the left when the patient lifts his right leg, allowing the clinician to conclude that the patient has an increased risk of falling.

Where there is data from previous sessions with the patient, the clinician may further choose to perform a trend analysis and determine the patent's rate of deterioration or improvement using analysis submodule 440. These analyses assist the clinician in evaluating the patient's progression and projecting their future abilities, allowing the clinician to establish a diagnosis and plan of care that is most appropriate for the patient.

In some embodiments of the Applicant's system, data can enter the system through interoperability interfaces with electronic health records and electronic medical records to which the clinician conducting the assessment has access. These data from prior clinical assessments can then be selected and portrayed in a graphic user interface that simultaneously portrays prior data, progress notes, diagnoses, and care plan with the current assessment images, comments, and drawing annotations. As those familiar with art will understand, a variety of analytical tools such as trending software statistical analyses, graphical visualizations, and summary dashboards can be integrated with the Applicant's system to provide high level data and data analyses within the interpretive graphic user interface provided by the

The synchronized video-audio data and analysis are then stored in memory 130 or data storage 180 using data storage submodule 410. In the present example, the data and analysis are stored based on standard and well known techniques for storing and retaining integrity and privacy of patient records. The clinician may further export a record of the session and analysis using export submodule 450 to a flash drive or other portable electronic data storage medium, which the patient can then to provide to his primary care physician to ensure continuity of care. The clinician may additionally provide the patient with a print out of the analysis and any dictated, dictated and transcribed, or clinician typed comments as well as any drawing annotations the clinician made along with the associated frames from the synchronized video-audio data files.

In some embodiments, clinician oral and written comments, along with respective drawing annotations, may be loaded directly through the system's interoperability interface to an electronic health record or electronic medical record with appropriate meta tags so that these data may be brought back into the Applicant's system when the patient is assessed at a future time. In addition, the Applicant's system provides meta tags that can be used by electronic health records or electronic medical records for use in constructing customized patient education for those types of electronic records that are coupled to patient education systems.

In some embodiments, the Applicant's system also allows engagement by the patient in learning assessment activities that assess the patient's understanding of their condition based on their review of the video-audio streams of an assessment and the comments and drawing made by the clinician conducting the respective assessment. In these embodiments, the interoperability interfaces with electronic health records or electronic medical records allow interchange of information directed by the clinician or operator of the Applicant's systems in ways that load information and additional data from the larger data sets within the electronic records and any educational systems coupled to the records. Consequently, the interchange of information and data from electronic records and patient educational systems can be sensibly combined with the data just obtained from an assessment to evaluate the patient's understanding of their immediate condition as well as the history and course of their condition.

While the preferred embodiments of the present invention have been illustrated in detail, it should be apparent that modifications and adaptations to those embodiments may occur to one skilled in the art without departing from the scope of the present invention.

What is claimed is:

1. A system for assessing an individual comprising a server comprising a processor and a non-transitory computer readable medium, the non-transitory computer readable medium in communication with the processor, wherein the non-transitory computer readable medium has instructions encoded thereon to:
receive at least one video-audio data stream from at least one video camera in communication with the server;
establish a threshold for a parameter that can be measured using the at least one video-audio data stream;
measure the parameter using the at least one video-audio data stream; and
compare the measured parameter with the threshold.

2. The system of claim 1, wherein the non-transitory computer readable medium further has instructions encoded thereon to synchronize the at least one video-audio data stream.

3. The system of claim 1, wherein the non-transitory computer readable medium further has instructions encoded thereon to quantify a deviation of the parameter.

4. The system of claim 1, wherein the non-transitory computer readable medium further has instructions encoded thereon to perform a trend analysis of the parameter.

5. The system of claim 1, wherein the non-transitory computer readable medium further has instructions encoded thereon to determine the rate of change of the parameter.

6. The system of claim 1, further comprising a wireless communication module, wherein the wireless communication module is configured to received medical diagnostic data from one or more devices external to the system, wherein the medical diagnostic data is selected from the group consisting of blood pressure data, blood sugar data, pulse rate data, MRI imaging data, ultrasound imaging data, and X ray imaging data.

7. A method of assessing an individual comprising:
providing at least one video camera;
providing a server in communication with the video camera, the server comprising a processor and a non-transitory computer readable medium, the non-transitory computer readable medium in communication with the processor, wherein the non-transitory computer readable medium has instructions encoded thereon to:
receive at least one video-audio data stream from the at least one video camera in communication with the server;
establish a threshold for a parameter that can be measured using the at least one video-audio data stream;
measure the parameter using the at least one video-audio data stream; and
compare the measured parameter with the threshold;
capturing a video-audio data stream for each of the at least one video cameras;
establishing a threshold for the parameter;
measuring the parameter; and
comparing the parameter with the threshold.

8. The method of claim 6, wherein the non-transitory computer readable medium further has instructions encoded thereon to synchronize the at least one video-audio data stream, the method further comprising synchronizing the at least one video-audio data stream.

9. The method of claim 6, wherein the non-transitory computer readable medium further has instructions encoded thereon to quantify a deviation of the parameter, the method further comprising quantifying the deviation.

10. The method of claim 6, wherein the non-transitory computer readable medium further has instructions encoded thereon to perform a trend analysis of the parameter, the method further comprising performing a trend analysis.

11. The method of claim 6, wherein the non-transitory computer readable medium further has instructions encoded thereon to determine the rate of change of the parameter, the method further comprising determining a rate of change.

12. The method of claim 7, further comprising:
wirelessly receiving medical diagnostic data from one or more devices external to the system, wherein the medical diagnostic data is selected from the group consisting of blood pressure data, blood sugar data, pulse rate data, MRI imaging data, ultrasound imaging data, and X ray imaging data;
interleaving said medical diagnostic data with said video-audio data stream.
